(19) United States
(12) Patent Application Publication
(10) Pub. No.: US 2023/0175879 A1
(43) Pub. Date: Jun. 8, 2023

(54) BUCKET WITH INTERIOR MEASUREMENT MARKINGS

(71) Applicant: Stewart Guilford, Sabattus, ME (US)

(72) Inventor: Stewart Guilford, Sabattus, ME (US)

(21) Appl. No.: 17/815,788

(22) Filed: Jul. 28, 2022

Related U.S. Application Data
(60) Provisional application No. 63/286,911, filed on Dec. 7, 2021.

(51) Int. Cl. G01F 23/00; B65D 1/40

(52) U.S. Cl. CPC G01F 23/0007; B65D 1/40

(57) ABSTRACT

Embodiments of the present invention include a bucket that makes it easier for a user to identify the level of a substance in a bucket. In order to achieve this, the bucket includes an interior portion that defines a cavity for receiving a substance. The interior portion includes interior measurement markings on an interior sidewall of the interior portion, which allows the user to directly visually inspect the level of the substance in the bucket.

### CROSS-REFERENCE TO RELATED APPLICATION

This application claims the benefit of priority of U.S. provisional application No. 63/286,911, filed Dec. 7, 2021 the contents of which are herein incorporated by reference.

### BACKGROUND OF THE INVENTION

The present invention relates to measurement buckets and, more particularly, to a five-gallon bucket with measurements up to five gallons and nineteen liters on the interior.

Currently, buckets, and in particular five-gallon buckets, show measurements only up to three and a half gallons and fourteen liters on the exterior of the bucket only. Thus, it is difficult to measure up to five gallons with no clear markings of measurements. Further, with the marking being disposed on the outside of the bucket, it is difficult and time-consuming to view how much material is in the bucket.

As can be seen, there is a need for a bucket that ameliorates the aforementioned problems.

### SUMMARY OF THE INVENTION

In one aspect of the present invention, a bucket includes: an exterior portion; and an interior portion that: defines a cavity for receiving a substance, and comprises an interior sidewall with interior measurement markings defined thereon.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of h present invention, in use;

FIG. 2 is a perspective view of the embodiment of the present invention;

FIG. 3 is a front view of the embodiment of the present invention; and

FIG. 4 is a section view of the embodiment of the present invention, taken along line 4-4 in FIG. 2.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, an embodiment of the present invention provides a bucket comprising an interior portion and an exterior portion, the interior portion defining a cavity for receiving a material, and the interior portion further including measuring markings on an interior sidewall of the interior portion.

Embodiments of the present invention may show measurements up to five gallons and nineteen liters on the interior as well as conventional exterior measurements. Advantageously, the interior markings greatly ease the measuring process while filling the bucket because the user can simply view from the top and look straight down into the bucket (as opposed to for example, stopping filling, looking at the outside of the bucket, and then continuing to pour). The present invention makes it significantly easier to visually measure whatever material/substance is being put into the bucket.

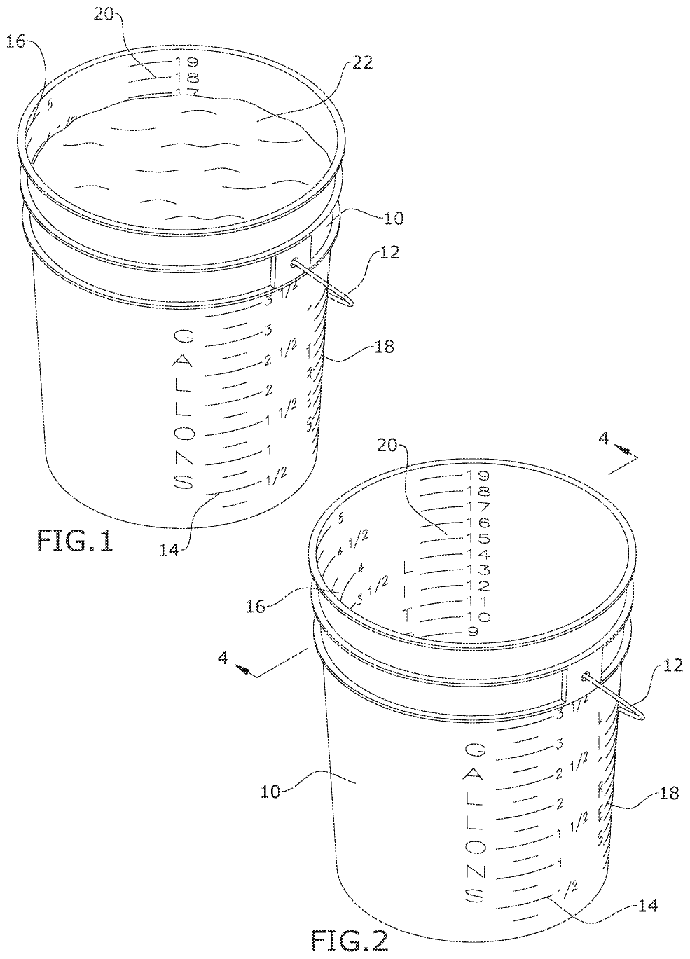

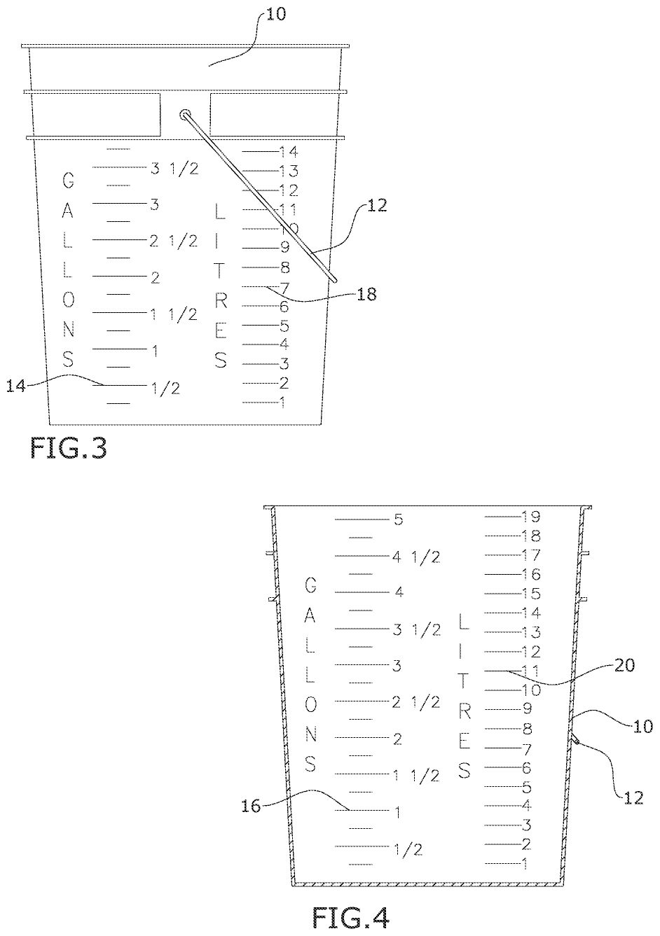

Referring now to FIGS. 1-4, a bucket 10 is shown. In certain embodiments, the bucket 10 is a five-gallon bucket. The bucket has an outer side, an interior side, and, in certain embodiments, may include a handle 12. The outer side of the bucket 10 may include a plurality of outer measurement markings 14, 18 denoting different measurement systems, such as the US customary system (gallon markings 14) or the metric system (liter markings 18). Advantageously, embodiments of the present invention include a plurality of interior markings 16, 20 on the interior side of the bucket 10 that align with the outer markings 14, 18. Like the outside of the bucket 10, the interior markings 16, 20, may include markings for different measurement systems, such as the US customary system (gallon markings 16) or the metric system (liter markings 20). As shown in FIG. 4, the gallon interior markings 16 may be provided in quarter gallon increments.

Thus, a user filling the bucket 10 can simply look inside the bucket 10 as the user is pouring/dumping any material/substance into the interior 120 of the bucket 100. Further, as discussed above and shown in FIG. 4, the interior measurement markings 16, 20 may be marked continuously up the sidewalls all the way to the maximum volumetric capacity of the bucket 10 (such as 5 gallons or 19 liters). In other embodiments, other units to mark volumetric capacity may be used (such as 14 quarts on the exterior and 20 quarts on the interior as opposed to gallons). It will be appreciated that other measurement systems and units are envisioned and in accordance with the present invention. Thus, any amount up to the capacity of the bucket 10 may be accurately measured.

While a method of making the present invention would be readily apparent from the foregoing disclosure, it may also include the following. First, a bucket (made from, for example, plastic) is formed using any number of manufacturing methods. Then, markings 14, 16, 18, 20 on the inside and outside of the bucket 10 may be either engraved or otherwise visibly marked on sidewalls of the bucket 10. In certain embodiments, the inner 16, 20 and outer 14, 18 markings may be placed adjacent one another (in alignment) on opposite sides (inner and outer) of the bucket 10. A method of using the present invention may include the following. Referring to FIG. 1, as a substance 22 (e.g., water, sand, and other materials for measurement) is poured into the bucket 10, a user looks in the bucket 10 as the material 22 fills the bucket 10 and stops pouring once the desired amount of material 22 has been put into the bucket 10.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A bucket comprising:
an exterior portion; and
an interior portion that:
defines a cavity for receiving a substance, and
comprises an interior sidewall with interior measurement markings defined thereon.

2. The bucket of claim 1, wherein the interior measurement markings go up to five gallons.

3. The bucket of claim 2, further comprising exterior measurement markings.

4. The bucket of claim 3, wherein the interior measurement markings are aligned with the exterior measurement markings.

5. The bucket of claim 2, wherein the interior measurement markings are provided in quarter gallon increments.

6. The bucket of claim 1, wherein the interior measurement markings comprise a plurality of gallon markings and a plurality of liter markings.
